(19) United States
(12) Patent Application Publication
(10) Pub. No.: US 2005/0254593 A1
(43) Pub. Date: Nov. 17, 2005

(54) Doppler aided detection, processing and demodulation of multiple signals

(76) Inventors: Philip Moser, Falls Church, VA (US); Sonetra Howard Wilburn, Ashburn, VA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/101,652

(22) Filed: Apr. 8, 2005

Related U.S. Application Data
(60) Provisional application No. 60/560,252, filed on Apr. 8, 2004.

(51) Int. Cl. H04N 5/21

(52) U.S. Cl. 375/295; 375/324

(57) ABSTRACT

Multiple co-channel signals are received at the same time. The co-channel signals are separated and demodulated within a frequency range by using the Doppler shift, or offset, of the co-channel signals. The signals are isolated by determining the peaks of the signals within the subchannel, or bin. A threshold is applied to the peaks to separate signals from noise and clutter. The individual peaks are compared to a baseband frequency to determine the Doppler shift. Those signals above the threshold are processed and demodulated.

### CROSS REFERENCE TO RELATED APPLICATIONS

This patent application claims priority under 35 USC § 119(e) to the following co-pending patent application: U.S. Provisional Patent Application Ser. No. 60/560,252, filed Apr. 4, 2004, and entitled “Doppler Aided Detection and Demodulation of Multiple FM Signals,” the contents of which are hereby incorporated by reference.

### BACKGROUND OF THE INVENTION

1. Field of the Invention

The present invention relates to the processing of multiple signals. More particularly, the present invention relates to the detection and demodulation of multiple signals transmitted at the same carrier frequency using the Doppler shift.

2. Description of Related Art

Frequency modulation (FM) discriminators detect the strongest signal in the frequency band. Many signals are transmitted at the same frequency and received via satellite receivers and other moving sources. After FM demodulation, the receiver may capture the signal with the highest power or signal-to-noise ratio (SNR), while considering the remaining signals as noise. This aspect of conventional discriminators, however, may ignore the fact that user of the received data is interested in other signals instead of just the signal with the highest SNR.

Joint detection of signals, such as co-channel signals, is an issue when trying to increase the capacity of a wireless system. For example, satellite receivers may acquire many signals transmitted at the same frequency and power. To the satellite, these signals may appear as one signal at the same frequency. Thus, FM discriminators may not work for these signals or systems.

For example, in a conventional signal processing system, the signals or a desired signal plus interference, or interfering signal, may be in a single time slot. Conventional demodulation techniques may be used to process the signals by the system to meet the desired performance. The signals may be detected, decoded and synchronized to a frame.

Bytes of information may be decoded to determine whether further processing is needed of the received message. If the message passes a validity check, the bits are processed and stored, or transmitted, to ground for further processing. If the message does not pass the validity check, then the processing may be discontinued and the messages are transmitted to ground. The applicable specification may dictate the number and frequency of the messages transmitted to ground.

The specification, however, may not address the issue of multiple signals in the same time slot. This issue may not be a problem for ground or near ground receivers, but not addressing multiple signals could become a problem for satellite receivers that move with relation to other system components and have large radio frequency fields of view. The satellite receiver may be bombarded by many different signals arriving in the time slot. Further, the inability to detect and demodulate multiple signals may become a dominant error source for these systems.

For example, some signal waveforms are not coded. In a time division multiplexed access (TDMA) channel, no code may be used to separate the overlapping signals, such as might be available for a code division multiplexed access (CDMA) channel. The signals may be superimposed in a TDMA channel so that the overlapping signals appear as one waveform to the receiver.

When tolerable frequency separation is not available, an interference cancellation (IC) method may be used to discern the different signals. For example, interfering signal waveforms are removed from the received signal waveform one at a time. Multiple iterations of the IC methods are continued until all of the possible signals are detected, or until the subsequent signal waveforms have weaker power. Thus, the most prevalent signal may be removed from the waveform, then the second most prevalent, and so on. An IC method, however, may be computationally intensive by going through numerous removal iterations and may not properly identify all the interfering signals.

### SUMMARY OF THE INVENTION

A method for processing at least one signal is disclosed. The method includes heterodyning the signal(s) to a baseband frequency. The method also includes detecting at least one peak within the receiver passband. The method also includes determining a Doppler shift for at least one signal. The method also includes isolating at least one signal by determining whether its peak is above a threshold for a frequency bin. The method also includes demodulating the signal with the Doppler shift.

A method for demodulating signals also is disclosed. The method includes detecting a plurality of signals within a frequency bin. The plurality of signals is received at a same instance. The method also includes determining if a signal of the plurality of signals equals or exceeds a threshold for the frequency bin. The method also includes determining a Doppler shift for the signal in relation to a baseband frequency. The method also includes demodulating the signal.

A signal processing system also is disclosed. The signal processing system includes an antenna to receive a plurality of signals. The signal processing system also includes a peak detector to detect a peak with the plurality of signals. The signal processing system also includes a separation detector to determine an offset from a baseband frequency for the peak. The signal processing system also includes a statistical detector to calculate a threshold for the plurality of signals. The signal processing system also includes a filter to separate the peak from noise within the plurality of signals and to identify a signal from the plurality of signals according to the peak.

A signal processing device also is disclosed. The device includes a peak detector to identify a peak within a plurality of signals. The device also includes a separation detector to determine an offset for the peak from a baseband frequency. The device also includes a low pass filter to isolate the peak from noise within the plurality of signals and to identify a signal from the plurality of signals.

A signal processing system also is disclosed. The system includes heterodyning means for heterodyning at least one signal to a baseband frequency. The system also includes detecting means for detecting at least one peak within a plurality of signals. The system also includes determining means for determining a Doppler shift for at least one signal. The system also includes isolating means for isolating at least one signal by determining whether at least one peak is above a threshold for a frequency bin. The system also includes demodulating means for demodulating at least one signal with the Doppler shift.

A signal processing system also is disclosed. The system includes detecting means for detecting a plurality of signals within a frequency bin. The plurality of signals is received at a same instance. The system also includes first determining means for determining if a signal power of the plurality of signals equals or exceeds a threshold for the frequency bin. The system also includes second determining means for determining a Doppler shift for the signal in relation to a baseband frequency. The system also includes demodulating means for demodulating the signal.

### BRIEF DESCRIPTION OF THE DRAWINGS

For proper understanding of the disclosed embodiments of the present invention, reference should be made to the attached drawings that are included to provide further understanding of the illustrated embodiments and their equivalents, and to explain examples of the present invention.

FIG. 1 illustrates a system for detecting, processing and demodulating a signal according to the disclosed embodiments.

FIG. 2 illustrates a separator for co-channel separation of signals according to the disclosed embodiments.

FIG. 3 illustrates signals and their peaks within a signal sample according to the disclosed embodiments.

FIG. 4 illustrates a system for isolating and detecting signals for demodulation according to the disclosed embodiments.

FIG. 5 illustrates a flowchart for demodulation and processing of signals according to the disclosed embodiments.

### DETAILED DESCRIPTION OF THE PREFERRED EMBODIMENTS

Reference is now made in detail to the preferred embodiments of the present invention. Examples of the preferred embodiments and their equivalents are illustrated by the accompanying drawings.

According to the disclosed embodiments, a signal of interest and co-channel signals are not differentiated. The disclosed embodiments may separate and demodulate a number of the signals impinging on an antenna. Increased probability exists of many co-channel signals being in a time slot. The co-channel signals may have the same spectral efficiency. The co-channel signals also may have a higher probability of error with other co-channel signals because of conditions prevalent with a satellite receiver.

From observation of the frequency spectrum of received signals, multiple signals of interest may be detected. The disclosed embodiments may isolate the signals based on the different Doppler frequency shifts exhibited by the individual signals. The disclosed embodiments may determine a statistical threshold to find the individual signals' amplitude peaks above a noise floor in the frequency spectrum. The statistical threshold may be calculated, for example, using a linear piecewise maxima algorithm.

The disclosed embodiments also may determine the Doppler frequency offset of each signal of interest, isolate each signal by heterodyning the signal to baseband and low pass filtering using the bandwidth of the signal, and demodulate the signal.

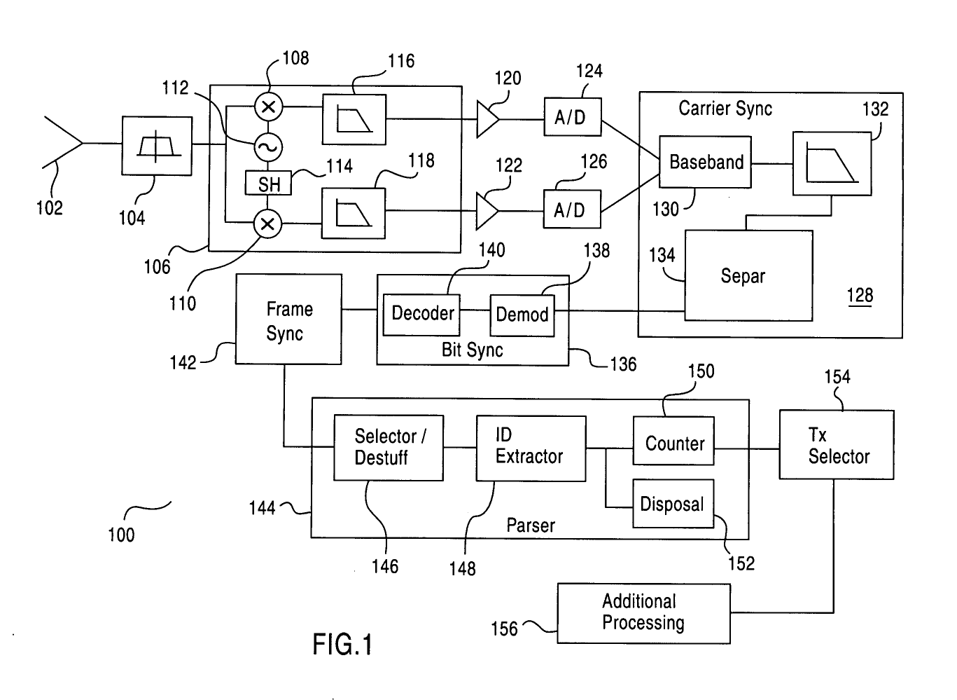

FIG. 1 depicts a system 100 for detecting, processing and demodulating a signal according to the disclosed embodiments. System 100 includes components for receiving and processing a signal or multiple signals. The signals may be RF signals. Further, the signals may be emitted from sources that are in motion. Alternatively, the observer, or receiver, of the signals may be in motion. Thus, a shift in frequency of the received signals may exhibit according to, for example, the Doppler affect. Thus, the received signals may include a Doppler shift. The Doppler shift may be a positive or negative shift.

System 100 may include antenna 102. Antenna 102 may be any conventional antenna capable of receiving signals. Antenna 102 also may transmit signals. Antenna 102 may couple to additional components and processing devices in addition to those shown in FIG. 1. Signal bin 104 is generated by antenna 102. Signal bin 104 may have a bandwidth of a certain amount, or between certain frequencies. For example, signal bin 104 may have a bandwidth between 161 and 162.5 megahertz (MHz). Multiple signals received on antenna 102 may have different bandwidths or different frequencies than those in signal bin 104. The frequencies of interest may be specified.

Signal bin 104 may include a plurality of signals along with noise and clutter detected within the frequency range. Signals within signal bin 104 may include a primary signal along with secondary, or co-channel, signals. These signals may include peaks having certain values that distinguish the signals from clutter or noise and other signals.

Further, signal bin 104 may be considered to be with other bins that are processed according to the disclosed embodiments. Signal bin 104 also may establish a center frequency within the channel that corresponds to the middle of the bandwidth. This center frequency may be referred to as baseband, and may have a reference point of zero (0) within signal bin 104.

System 100 also includes receiving processor 106 that receives signal bin 104. Receiving processor 106 also may receive additional signal bins from different sources or antennas to process multiple signals. Receiving processor 106 includes mixers 108 and 110. Mixers 108 and 110 may heterodyne, or multiply, reference signal 112 with the signals within signal bin 104. Reference signal 112 may be a reference sinusoid.

Shift 114 may shift reference signal 112 such that mixer 110 does not output the same signal as mixer 108. Preferably, mixer shift 114 shifts reference signal 112 by about 90°, or degrees. For example, signal 104 is heterodyned by mixer 108 to produce the cosine (in-phase) reference signal, while mixer 110 heterodynes signal 104 to produce the sine (quadrature) reference signal. Both output signals are passed through low pass filters 116 and 118. Low pass filters 116 and 118 may remove noise from the output signals.

Gates 120 and 122 pass the output signals to converters 124 and 126, respectively. Converters 124 and 126 may be analog-to-digital (A/D) converters that convert the analog RF signals to digital signals. These converted signals may then be passed to carrier sync 128. Carrier sync 128 may determine what signals are present in signal bin 104.

Carrier sync 128 includes baseband module 130. Baseband module 130 may take the output signals of converters 124 and 126 and determine a baseband center frequency for signal bin 104. According to the disclosed embodiments, the baseband center frequency may serve as a reference point of zero for subsequent signal processing.

Signal bin 132 may be generated that includes the signals of signal bin 104, but centered around the baseband frequency. Signal bin 132 may be a sample set of signals based on the baud rate and time length of a signal. The sample set may include peaks of multiple signals that are within the bandwidth of the channel.

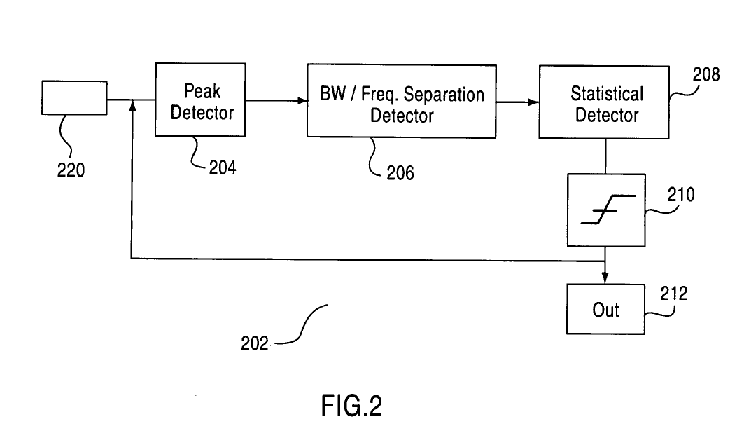

Separator 134 receives signal bin 132 and performs detection and separation of signals of interest within the sample set. Separator 134 may perform co-channel signal separation using frequency separation. Separator 134 is disclosed in greater detail with reference to FIG. 2. Once the signals are detected and separated, the output of separator 134 is passed to bit sync 136.

Bit sync 136 includes demodulator 138 and decoder 140. As an example, demodulator 138 maybe a Gaussian Minimum Shift Keyed (GMSK) or other digital communicatons modulation scheme demodulator and decoder 140 maybe a Non-Return-to-Zero-Inversion (NRZI) or other digital pulse coded modulation (PCM) scheme decoder. Demodulator 138 may detect signals using orthogonal coherent detectors and data windows that complement the reference carrier and timing recovery algorithms. Bit sync 136 outputs the decoded information to frame sync 142. Frame sync 142 may take the information and place it into a data frame for further processing.

The data frame may be received by parser 144 which includes selector/destuffing module 146, identity extractor 148, and counter 150. Parser 144 may perform partial parsing of the information, or message, from decoder 140 and frame sync 142. Byte selector/bit destuffing module 146 may decompress information as needed. Identity extractor 148 may determine an identity of the information, or message. Counter 150 may be a message identification counter.

Parser 144 also may include message disposal 152 that serves to dispose a failed message or errors. Parser 144 may output the parsed message, or information regarding the message, to transmitter selector 154. Transmitter selector 154 may forward the message to additional processing components 156 for other operations on the message, such as byte alignment, bit swapping, bit de-stuffing, displaying the message and the like.

Thus, FIG. 1 depicts system 100 that includes separation, demodulation, and detection of signals of interest that are decoded into messages or information. The signals of interest may be within a channel, or between a specified bandwidth, as disclosed by signal bin 104. The signals may be offset from a baseband frequency and have peaks that are above a threshold determined for the channel.

FIG. 2 depicts separator 202 for co-channel separation of signals according to the disclosed embodiments. Separator 202 may correspond to separator 134 depicted in FIG. 1, but separator 202 is not limited by the disclosure of separator 134. Likewise, separator 134 is not limited by the disclosure with reference to FIG. 2.

Separator 202 includes peak detector 204, separation detector 206 and statistical detector 208. Separator 202 also includes low pass filter 210 and output 212. Separator 202 may receive a heterodyned signal sample 220. Signal sample 220 may be output from a baseband component that determined the baseband frequency within a channel, or bandwidth, of the signals within signal sample 220. For example, signal sample 220 may include a plurality of signals within a time bin, or frequency bin. An example of a set of signals within a sample is disclosed in greater detail below.

Peak detector 204 of separator 202 may search the bin of data of signal sample 220 to determine, or isolate, maxima within the frequency spectrum. For example, if 5 signals are present in signal sample 220, then peak detector 204 may determine 5 maxima points within the bin. Preferably, the bins are fast Fourier transforms (FFT) of the data within the samples. Peak detector 204 may be limited to a certain number of maxima points so that only the strongest signals are detected. Alternatively, peak detector 204 may not be limited to the number of maxima detected. Further, peak detector 204 may search multiple bins within a frequency range.

Separator 202 also includes bandwidth/frequency separation detector (“separation detector”) 206. Separation detector 206 receives the maxima of signal sample 220 detected by peak detector 204 and determines Doppler frequency offsets of the maxima, and their corresponding signals, in relation to the baseband, or zero, frequency for signal sample 220. Thus, each detected potential signal may have a Doppler offset from the baseband of the frequency bin. The Doppler offset is used to distinguish the potential signals from each other, and may be assigned a frequency value. The value may be positive or negative.

Separation detector 206 outputs the maxima, or detected peaks, with their Doppler offsets to statistical detector 208. Statistical detector 208 determines, or calculates, a threshold for signal samples 220. The threshold is used to determine whether the detected peak relates to noise or a potential signal. Receiver and environmental random noise and clutter may be present as well as multiple desired signals of interest within the receiver's operating bandwidth. The noise and clutter may find its way to the signal samples, or bins, received at separator 202. For example, if the peak is above the threshold, then it probably corresponds to a desired signal and is forwarded for further demodulation or processing. If the peak is below the threshold, then it probably corresponds to noise or clutter, and is discarded. Thus, statistical detector 208 may reduce false alarm rates and improve resource allocation because demodulation or processing operations do not occur on noise and clutter.

The threshold generated by statistical detector 208 may be determined according to conventional processes or algorithms. For example, statistical detector 208 may determine an average over all the signal samples, or FFT bins, and apply a 95% chi-squared hypothesis algorithm to the averages to determine the threshold. Other algorithms also may be used to set the threshold to a desired level. The desired level may correspond to a specified or desired false alarm rate. Thus, the disclosed embodiments may minimize false alarms in signal demodulation and processing. Advantages, however, may be found by storing the threshold for retrieval by statistical detector 208. Processing components may be eliminated, and variance may not occur from the desired threshold.

Alternatively, the threshold of statistical detector 208 may be determined a priori from a system specification or the like. As noted above, the preferred process is a least squares estimation method that determines the proper statistical threshold for minimizing false alarm, such as a 95% chi-squared hypothesis detection. Advantages, however, may be found by storing the threshold for retrieval by statistical detector 208. Processing components may be eliminated, and variance may not occur from the desired threshold.

Threshold Detector 210 applies the threshold generated by statistical detector 208 to the detected peaks and their Doppler offsets. As noted above, the peaks, or signals, that exceed the threshold, may be forwarded to output 212. Thus, Threshold Detector 210 extracts, or isolates, multiple signals of interest from the data within signal sample 220.

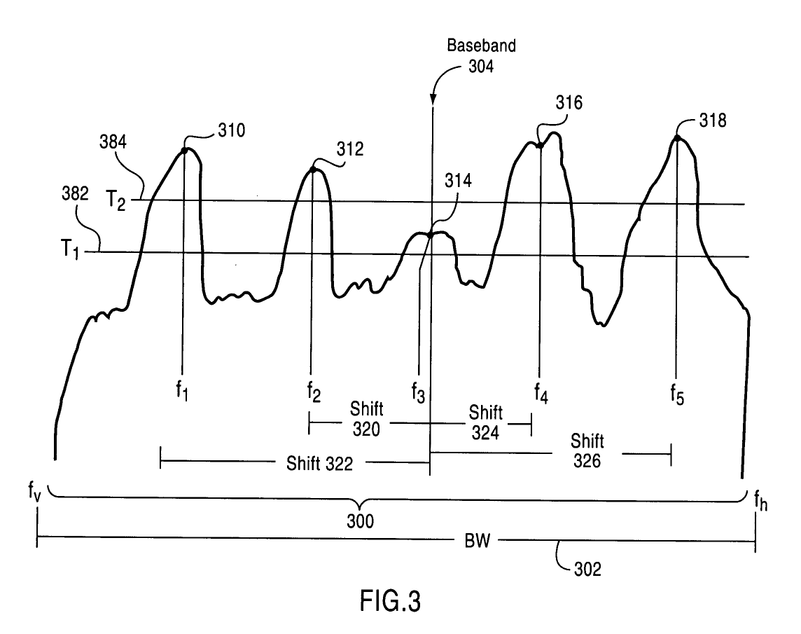

FIG. 3 depicts signals 300 and their peaks within a signal sample according to the disclosed embodiments. Signals 300 may be within a signal sample, or a frequency bin, according to the disclosed embodiments. Further, signals 300 may be in a bandwidth channel 302 of a frequency range. Bandwidth channel 302 may be between two frequency values, fₕ and fₗ.

Peaks 310, 312, 314, 316 and 318 also are depicted in FIG. 3. Peaks 310-318 are detected by determining the maxima of the frequency spectrum of the sample set of signals 300. Signals 300 may include additional peaks, less peaks, or no peaks than the ones shown. Peaks 310-318 may correspond to potential signals within bandwidth 302. Peaks 310-318 represent the received energy level at frequencies within bandwidth channel 302. For example, peak 310 may be located at frequency f₁, peak 312 may be located at frequency f₂, peak 314 may be located at frequency f₃, peak 316 may be located at frequency f₄, and peak 318 may be located at frequency f₅. All frequencies f₁-f₅ are between fₕ and fₗ.

Signals 300 are co-channel signals within bandwidth channel 302. Co-channel signals may be subject to overlap in TDMA systems due to bursts of data or information. Data in TDMA systems and components may be burst, for example, from a transmitter to a receiver. During demodulation, the burst of data from one block may include interference with other bursts. For example, 2-4 bursts may interfere with another burst of data that results in multiple bursts being received at the same instance.

Some of the interfering bursts may have their effects reduced using known parameters and treated as noise, but other burst waveforms may have significant overlap that is not reducible using the known parameters. A demodulation component may not be able to treat the burst as noise or data. In a TDMA channel, the signal waveforms may not be coded, so code may not be used to separate the overlapping signals. A problem may occur as the signals are superimposed upon each other in the TDMA channel, and may appear as one waveform.

Baseband, or center, frequency 304 may be determined for bandwidth channel 302 to provide a reference for signals 300. Baseband frequency 304 may be determined, as discussed above, by heterodyning the received signals with reference signals. Baseband frequency 304 may serve as the reference point for determining the Doppler shift of the detected peaks within signals 300. Thus, baseband frequency 304 may have a Doppler shift of zero (0).

Peak 310 is not on baseband frequency 304. Thus, peak 310 has a Doppler shift 322 from baseband frequency 304. Other peaks also have Doppler shifts from baseband frequency 304. For example, peak 312 has a Doppler shift 320, peak 316 has a Doppler shift 324, and peak 318 has a Doppler shift 326. Peak 314 may be located on baseband frequency 304, or, alternatively, peak 314 also may have a minimal offset from baseband frequency 304. Thus, multiple signals that may overlap or interfere to look like one signal in conventional processing and demodulation systems are distinguishable according to the disclosed embodiments. If baseband frequency 304 represents a point in time, then peaks 310-318 and Doppler shifts 320-326 represent the different signals arriving at that point in time. The disclosed embodiments separate the different signals for better detection and demodulation.

As disclosed above, a threshold may be determined for the channel, or bin, that is used to determine whether a peak of a signal of interest corresponds to a signal or is noise or clutter. Referring to FIG. 3, a first threshold, or threshold 382, may be determined by calculating the statistical threshold according to a least squares method. Peaks in signals 300 above threshold 382 may correspond to signals of interest within bandwidth channel 302. Peaks in signals 300 identified in bandwidth channel 302 below threshold 382 may be noise or clutter components that are removed or ignored in subsequent demodulation and processing operations. For example, all of peaks 310-318 are located above threshold 382.

In addition, a second threshold, or threshold 384, may be determined for bandwidth channel 302. Threshold 384 may be a higher statistical threshold than threshold 382, and may be calculated according to a different least squares method. For example, threshold 384 may be used to further minimize the false alarm rate in signals 300. Thus, peaks 310, 312, 316 and 318 are located above threshold 384, and correspond to potential signals within signals 300. Peak 314, however, is located below threshold 384, and may be considered to correspond to noise or clutter within signals 300. The potential signal having peak 314 may not be subject to subsequent processing or demodulation. Resources may be saved by not demodulating the potential signal having peak 314 because there is a high probability that it is noise that may not be reconstructed and has nothing to do with the transmission.

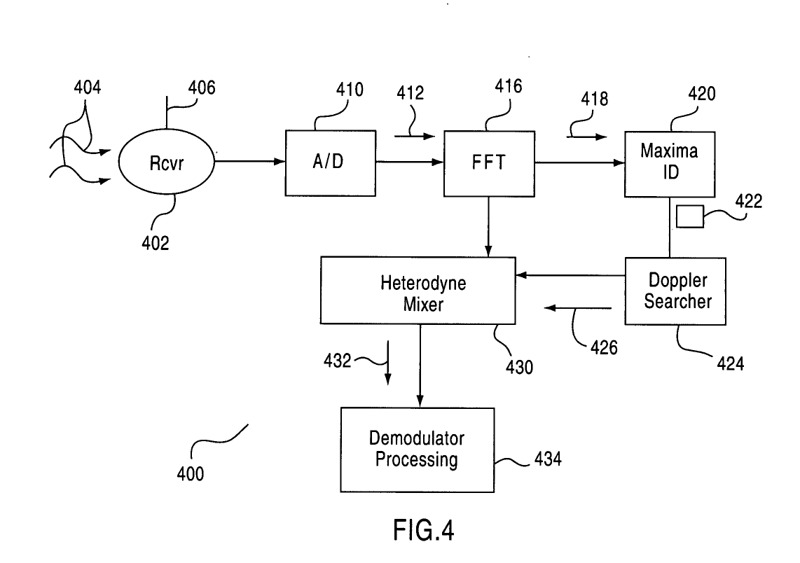

FIG. 4 depicts a system 400 for isolating and detecting signals for demodulation according to the disclosed embodiments. System 400 may receive analog signals 402 from a transmitter that is moving relative to system 400 or system 400 may be moving relative to the transmitter. For example, the transmitter may be located on a satellite in low Earth orbit.

As disclosed above, an apparent shift in frequency may occur because the transmitter or receiver is in motion. Depending on the direction of the motion, a Doppler shift may be positive or negative. System 400 receives signals 402 and detects signals of interest and separates the signals of interest from noise and clutter for processing and reconstruction using the Doppler shift information.

System 400 includes receiver 402 that receives signals 404. Receiver 402 may include an antenna 406 and additional components. Receiver 402 also may be a transceiver that transmits and receives signals 404. Receiver 402 is coupled to converter 410. Converter 410 may be an analog-to-digital (A/D) converter that changes signals 404 into digital signals 412 that are more appropriate for processing and demodulation within system 400.

System 400, and receiver 402, may intake frequency spectrum data that is separated into sample sets based on the baud rate of signals 404 and a time length of a message carried by one or more of signals 404. Thus, FFT module 416 converts the time domain digital signals 412 into frequency domain values that include the frequency spectrum data. Thus, signals 412 may become sample sets in frequency bins 418 within the frequency spectrum.

Maxima identifier 420 receives frequency bins 418 having the frequency domain values. Maxima identifier 420 may be a processor or other component that determines a threshold using a statistical analysis, or process, to provide a desired minimum false alarm rate. Maxima identifier 420 also may be a software component, block of code, or component that includes instructions executed to enact the disclosed functions. Maxima identifier 420 may take an average of all the frequency bins 418 to apply, for example, a 95% chi-squared hypothesis detection filter to minimize the detection false alarm rate. The filter may correlate to the threshold used to detect potential signals.

Maxima identifier 420 searches the data within frequency bins 418 to find the maxima, or peaks, of the frequency spectrum data. The peaks may correspond to higher signal levels, and should be associated with signals and not noise or clutter. If maxima, or peaks, are above the threshold, then a potential signal exists at the location of the peak. Noise and clutter should be located below the threshold and not detected by maxima identifier 420.

Maxima identifier 420 may be limited to the number of maxima found in a sample set. For example, processing limitations may specify that less than 6 signals may be properly detected and demodulated. If more than 5 peaks are detected, then the veracity of the demodulated results may be compromised. Thus, maxima identifier 420 may select the top 5 peak values from the sample set to forward onto subsequent processing. Resources desired for signal demodulation and processing may be considered according to the number of peaks identified. Alternatively, maxima identifier 420 may not be limited, and any number of peaks may be identified or detected. Maxima identifier 420 outputs data, or set 422 that includes the detected peaks.

Set 422 is received by Doppler searcher 424. Doppler searcher 424 determines the Doppler frequency of an incident signal corresponding to a detected peak in set 422. The incident signal may include an offset from a zero, or baseband, frequency in the applicable bin. A Doppler offset, or shift, is determined for all the identified maxima, or peaks. Thus, potential signals may be isolated according to their Doppler offset from the baseband frequency within a frequency bin. The disclosed embodiments may distinguish between different signals arriving simultaneously without significant noise or clutter problems.

Isolated signals 426 with their Doppler offsets are forwarded from Doppler searcher 424 to heterodyne mixer 430. Mixer 430 also may be a processor or other computing component that performs functions as disclosed. Alternatively, mixer 430 may be a software module, component, code and the like that includes instructions to perform the disclosed functions. Mixer 430 takes the sample set corresponding to the isolated signals and heterodynes each isolated signal to baseband using the calculated Doppler frequency. A low pass filter may be applied to each basebanded sample set to better isolate each of the detected signals under consideration.

Sample set 432 outputs from mixer 430 to demodulation processing 434. Demodulation processing 434 performs functions to demodulate the signals isolated in sample set 432 to determine the values of the signals. Signals may not have equal values. For example, if 5 signals have been isolated and identified in sample set 432, then all 5 signals probably will not be the same value, and, thus, may not be treated the same during processing.

For example, the value of multiple signals may be represented as (a+b) sin θ, or a sin θ+b sin θ. The value “a” may be for the first signal and “b” may be for the second signal. Values a and b may be important as they correspond to co-channel signals, and no process may be available to distinguish the values from one another. The expression (a+b) sin θ, however, may be approximately equal to a sin (θ+θ_{da})+b sin (θ+θ_{db}), where θ_{da} and θ_{db} are the Doppler offsets of the signals from the baseband. Using these expressions, the disclosed embodiments may determine the values of a and b in co-channel signals by using the Doppler shift values to separate and demodulate the signals. Demodulation processing 434 also may reconstruct the text of the message within receive signals 404. The disclosed functions may be repeated until all detected signals in the sample set have been extracted or processed.

Thus, system 400 may enhance the ability to demodulate multiple signals in an incident band. Synchronization of the bit sequence may be obtained along with the demodulation of multiple signals at the same frequency. System 400 allows interception and isolation of co-channel signals.

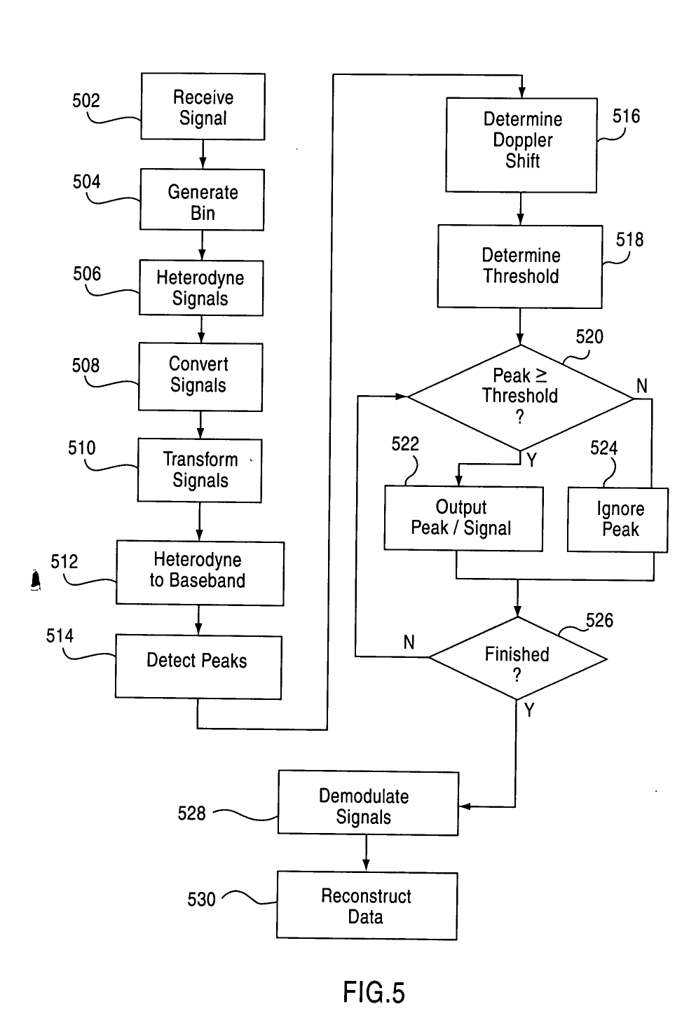

FIG. 5 depicts a flowchart for demodulation and processing of signals according to the disclosed embodiments. Step 502 executes by receiving signals at an antenna or transceiver. The signals may be RF signals that are subject to FM demodulation, as disclosed above. The antenna may be a single antenna, or, alternatively, an array of antennas. The antenna may separate the received signals into different spectrums.

Step 504 executes by generating a bin or plurality of bins for the signals within the spectrum. For example, the signals within a frequency spectrum may be divided into different bins have bandwidths of different frequencies within the spectrum. A bin may include a number of different signals received at the same time within the defined frequency spectrum.

Step 506 executes by heterodyning the signals within the bin with a reference signal or reference signals. One reference signal may be a cosine sinusoid signal, while another may be sine sinusoid signal. The reference signals may facilitate the determination of a baseband frequency for the bin, or a reference value for the signals within the bin. Further, an oscillating reference signal may be mixed with the incoming signals to help in later processing of the signals.

Step 508 executes by converting the signals. The conversion may be from analog signals to digital signals using an A/D converter. Step 510 executes by transforming the signals with the bin from the time domain to the frequency domain. For example, an FFT may be applied for the transformation. Once transformed, the bin includes peaks corresponding to signals.

Step 512 executes by heterodyning the signals in the signal bin to the baseband frequency. Thus, the signals may be referenced to the baseband frequency, or center, of the frequency band. The signals may be mixed, or heterodyned, with a reference signal corresponding to the baseband frequency.

Step 514 executes by detecting the amplitude peaks of the signals, or potential signals, within the signal bin, or subchannel. The number of peaks may vary. For example, the disclosed embodiments may detect 5 or less peaks. Alternatively, the disclosed embodiments may detect 9 or less peaks. As computational resources become more readily available, the number of peaks that are detected for potential demodulation may increase.

Step 516 executes by determining the Doppler shift for the detected peaks. Each peak may be offset from the baseband frequency by a Doppler shift value. The Doppler shift value may be positive or negative, or greater or less than the baseband frequency. Thus, the peak may be locatable by knowing the baseband frequency and the applicable offset. As the transmitter or receiver moves towards or away from the other, a Doppler shift may occur due to the change in frequency as the objects move.

Step 518 executes by determining a threshold to apply in the signal bin to separate noise from signals. The threshold may be calculated, as disclosed above, by using a least squares method. The threshold may be a statistical representation of the signal strengths for the individual bin or across a plurality of bins. The disclosed embodiments may seek a threshold that separates the noise at a certain integrity or confidence level, such as 95%, to minimize false alarms. If the acceptable false alarm rate is to be increased or decreased, the appropriate statistical value may be chosen.

Step 520 executes by determining whether a peak of the number of detected peaks is above or equal to the threshold. Peaks may be analyzed one by one to determine whether they are above the statistical threshold desired to isolate potential signals for demodulation. If yes, step 522 executes by outputting the peak of the signal, or the signal itself, for further processing. The signal output may include the Doppler offset from the baseband frequency.

If step 520 is no, then step 524 executes by ignoring the peak and removing the potential signal from consideration. Thus, steps 520-524 may isolate those peaks and corresponding Doppler offsets that are most likely signals for processing and demodulation. Although noise and clutter may be received along with multiple signals, the signals may be separated out without losing the integrity of the system. In other words, resources may not be allocated to demodulating noise and clutter.

Step 526 executes by determining whether the analysis of the peaks within the signal bin is complete. If not, then the flowchart returns to step 520 to review the next identified peak. If so, then all the peaks have been reviewed, and the separation process of the disclosed embodiments is complete. The next bin may be reviewed according to a new threshold, or, alternatively, the same threshold. Bins may be reviewed separately so as to customize the statistical threshold for a particular frequency and to take into account the different signal bandwidths or structures corresponding to the bins.

Step 528 executes by demodulating those signals that have been isolated by the previous steps. The signals should include their frequency and Doppler offset, or shift value. Demodulation may occur as disclosed above.

Step 530 executes by reconstructing the data from the information in the signals. For example, if the signal includes information for a message from a wireless source, then the disclosed embodiments may reconstruct that message. Using the features of the disclosed embodiments disclosed above, the reconstructed message should match the original messages transmitted as the received signal.

Therefore, the disclosed embodiments may obtain the captured data of a moving target or from a moving observer over a geographical area. Detection of co-channel signals with or without similar signal-to-noise ratios in the same frequency band may be performed. Separation of these signals and selection of those signals that are of interest also may be performed. Demodulation of the selected, or isolated, signals may be performed to reconstruct the data from the transmission.

The disclosed embodiments also may heterodyne the captured data to baseband data, using a baseband frequency. The baseband frequency may act as a reference frequency to the signals. The Doppler shift of the peaks of the signals may be exploited to separate the co-channel signals. Thus, the disclosed embodiments may create bins of the signal data based on the Doppler shifts, or offsets, and determine the piecewise maxima of the bins to collect, or isolate, the signals of interest.

As disclosed above, the disclosed embodiments enhance the ability to demodulate multiple signals in the incident frequency band. Synchronization of the bit sequence may be obtained and multiple signals at the same frequency are demodulated without the need for iterative strongest signal removal processes.

Thus, interception of co-channel signals using a single characteristic antenna may be achieved that reduces processing requirements and improves reliability. Further, real-time processing may be enhanced because the disclosed embodiments should not return to the sample signals, or data, and remove signals to capture the remaining signals.

The preceding discussion has presented various embodiments for detection and demodulation of multiple signals. As one of average skill in the art will appreciate, other embodiments may be derived from the teachings of the present invention as encompassed by the following claims without deviating from the scope of the claims and their equivalents.

1. A method for processing signals, the method comprising:
heterodyning at least one signal of a plurality of signals to a baseband frequency;
detecting at least one peak within the plurality of signals;
determining a Doppler shift for the at least one signal;
isolating the at least one signal by determining whether the at least one peak is above a threshold for a frequency bin; and
demodulating the at least one signal with the Doppler shift.

2. The method of claim 1, further comprising transform the at least one signal into the frequency bin.

3. The method of claim 1, further comprising reconstructing data from the at least one signal.

4. The method of claim 1, further comprising determining the threshold for the frequency bin using a statistical process.

5. A method for demodulating signals, the method comprising:
detecting a plurality of signals within a frequency bin, wherein the plurality of signals are received at a same instance;
determining if a signal power of the plurality of signals equals or exceeds a threshold for the frequency bin;
determining a Doppler shift for the signal in relation to a baseband frequency;
separating the plurality of signals; and
demodulating the signal.

6. The method of claim 5, further comprising detecting a peak within the signal, wherein the peak equals or exceeds the threshold.

7. The method of claim 5, further comprising determining the threshold using a statistical process.

8. The method of claim 7, wherein the statistical process comprises a least squares method.

9. The method of claim 5, further comprising converting the plurality of signals from a plurality of analog signals.

10. The method of claim 9, further comprising receiving the plurality of analog signals at an antenna.

11. A signal processing system comprising:
an antenna to receive a plurality of signals;
a peak detector to detect a peak within the plurality of signals;
a separation detector to determine an offset from a baseband frequency for the peak;
a statistical detector to calculate a threshold for the plurality of signals; and
a filter to separate the peak from noise within the plurality of signals and to identify a signal from the plurality of signals according to the peak.

12. The signal processing system of claim 11, wherein the filter comprises a low pass filter.

13. The signal processing system of claim 11, where the plurality of signals is within a frequency bin having a bandwidth.

14. The signal processing system of claim 13, wherein the threshold corresponds to the frequency bin.

15. The signal processing system of claim 11, further comprising a decoder to decode the signal.

16. A signal processing device comprising:
a peak detector to identify a peak within a plurality of signals;
a separation detector to determine an offset for the peak from a baseband frequency; and
a low pass filter to isolate the peak from noise within the plurality of signals and to identify a signal from the plurality of signals.

17. The signal processing device of claim 16, further comprising a statistical detector to determine a threshold for the low pass filter.

18. The signal processing device of claim 17, where the threshold corresponds to a statistical process using the plurality of signals.

19. The signal processing device of claim 16, wherein the plurality of signals are within a frequency bandwidth, said frequency bandwidth corresponding to a frequency bin.

20. A signal processing system comprising:
heterodyning means for heterodyning at least one signal of a plurality of signals to a baseband frequency;
detecting means for detecting at least one peak within the at least one signal within the plurality of signals;
determining means for determining a Doppler shift for the at least one signal;
isolating means for isolating the at least one signal by determining whether the at least one peak is above a threshold for a frequency bin; and
demodulating means for demodulating the at least one signal with the Doppler shift.

21. A signal processing system comprising:
detecting means for detecting a plurality of signals within a frequency bin, wherein the plurality of signals are received at a same instance;
first determining means for determining if a signal power of the plurality of signals equals or exceeds a threshold for the frequency bin;
second determining means for determining a Doppler shift for the signal in relation to a baseband frequency;
separating means for separating the plurality of signals; and
demodulating means for demodulating the signal.
